(19) United States
(12) Patent Application Publication
(10) Pub. No.: US 2018/0328385 A1
(43) Pub. Date: Nov. 15, 2018

(54) MASSAGE CHAIR HAVING A NOISE-REDUCING, ENCLOSURE DEVICE

(71) Applicants: KEVIN LE, RICHLAND HILLS, TX (US); THANH LE, GRAND PRAIRIE, TX (US); VARAD NITIN GOKHALE, IRVING, TX (US)

(72) Inventors: KEVIN LE, RICHLAND HILLS, TX (US); THANH LE, GRAND PRAIRIE, TX (US); VARAD NITIN GOKHALE, IRVING, TX (US)

(73) Assignee: LURACO TECHNOLOGIES, INC., ARLINGTON, TX (US)

(21) Appl. No.: 15/593,320

(22) Filed: May 11, 2017

(51) Int. Cl. F04D 29/66; A61H 9/00

(52) U.S. Cl. CPC F04D 29/664; A61H 2201/1238; A61H 2201/0149; A61H 9/005

(57) ABSTRACT

The present invention is directed to a massage chair having a massage chair frame, a massage system, and a noise-reducing, enclosure device. The massage chair frame includes a first end, a second end, a seat body area portion, and a back body area portion. The massage system includes at least one fluid massage element, a fluid pump, and at least one fluid valve device for regulating fluid flow into and out of the at least one fluid massage element. The noise-reducing, enclosure device includes an enclosure housing and noise-reducing material positioned inside the enclosure housing. The enclosure housing encloses the fluid pump and the plurality of fluid valve devices during operation during operation such that noise generated from or made by the fluid pump and the plurality of fluid valve devices during operation is reduced, contained or eliminated.

### BACKGROUND OF THE INVENTION

### Field of the Invention

The present invention generally relates to massage chairs, massage devices and apparatuses for massage chairs, and noise-reducing devices and systems. More specifically, the present invention is directed to a massage chair having a noise-reducing, enclosure device.

### Description of the Related Art

Massage chairs, massage devices and apparatuses for massage chairs, and noise-reducing devices and systems are known in the art.

In many current massage systems and devices related to massage chairs, the massage system or device usually has an air compressor to pump air into the air cells or bags throughout the massage chair to provide massage effects to users of the massage chair at air massage pressure points. Due to the electro-mechanical movement to generate the compressed air, the air compressor can make a very unpleasant noise when it operates. In addition, the air valves' operation to control the air flow into and out of air cells are also noisy. Thus, a massage chair having a noise-reducing, device or system is desired for reducing noise generated from and/or made by these devices so as to make the massage environment more quiet and relaxing for users of the massage chair.

The present invention overcomes one or more of the shortcomings of massage chairs, massage devices and apparatuses for massage chairs, and noise-reducing devices and systems. The Applicant is unaware of inventions or patents, taken either singly or in combination, which are seen to describe the present invention as claimed.

### SUMMARY OF THE INVENTION

The present invention is directed to a massage chair having a massage chair frame, a massage system that includes a plurality of fluid massage elements, and a noise-reducing (or noise-absorbing, noise-containing or noise-cancelling), enclosure device.

The massage chair frame includes a first end, a second end, a seat or bottom body area portion, and a back body area portion extending upward from the seat or bottom body area portion toward the second end. Preferably, the massage chair frame also includes a thigh body area portion located between the seat or bottom body area portion and the first end, a head and neck body area portion extending upward from the back body area portion and located about the second end, and a lower leg body area portion located downward (or extending downward) from the thigh body area portion and located about the first end.

The massage system comprises at least one fluid massage element, a fluid compressor or pump, and at least one fluid valve device for regulating fluid flow into and out of the at least one fluid massage element. Preferably, the massage system also comprises at least one fluid transport device and a power source. Also preferably, the at least one fluid massage element is a plurality of fluid massage elements, the at least one fluid valve device is a plurality of fluid valve devices, and the at least one fluid transport device is a plurality of fluid transport devices. The massage system is in operational communication with the massage chair frame such that the massage system provides massaging effects to a user positioned in the massage chair.

Each of the plurality of fluid massage elements is adapted for having fluid transported or pumped into it by the fluid compressor or pump and for having fluid withdrawn from it. The plurality of fluid massage elements may be positioned at predetermined massage locations on, about, or in the vicinity of the massage chair frame and/or may be moved or transported to desired massage locations by the user.

The fluid compressor or pump pumps fluid into the plurality of fluid massage elements such that massaging effects can be provided to the user at desired massage locations or pressure points.

The plurality of fluid valve devices regulate fluid flow into and out of the plurality of fluid massage elements.

The plurality of fluid transport devices transport fluid flow into and out of the plurality of fluid massage elements.

The power source provides power to the fluid compressor or pump, and may also be used to provide power to other components of the massage chair.

The noise-reducing (or noise-absorbing, noise-containing, or noise-cancelling), enclosure device comprises an enclosure housing and noise-reducing (or noise-absorbing, noise-containing, or noise-cancelling) material positioned inside the enclosure housing. The enclosure housing encloses the fluid compressor or pump and the plurality of fluid valve devices during operation. The noise-reducing, enclosure device is preferably positioned in proximity of the massage chair frame.

The enclosure housing encloses the fluid compressor or pump and the plurality of fluid valve devices during operation such that noise generated from or made by the fluid compressor or pump and the plurality of fluid valve devices during operation is reduced, contained or eliminated.

Preferably, the noise-reducing (or noise-absorbing, noise-containing, or noise-cancelling) material is positioned inside the enclosure housing in such a way that it surrounds the fluid compressor or pump and the plurality of fluid valve devices such that noise generated from or made by the fluid compressor or pump and the plurality of fluid valve devices during operation is reduced, contained or eliminated.

### BRIEF DESCRIPTION OF THE DRAWINGS

FIG. 1 is a right side, perspective view of a massage chair according to the present invention;

FIG. 2 is a perspective view of a massage chair frame for a massage chair according to the present invention;

FIG. 3 is a front view of the massage chair frame of FIG. 2;

FIG. 4 is a right side view of the massage chair frame of FIG. 2;

FIG. 5 is a rear, perspective view of a massage chair frame and a massage system of a massage chair according to the present invention;

FIG. 6 is a top, perspective view of a massage system and a noise-reducing, enclosure device of a massage chair according to the present invention;

FIG. 7 is a top, perspective view of the noise-reducing, enclosure device of FIG. 6;

FIG. 8 is a bottom, perspective view of the noise-reducing, enclosure device of FIG. 6;

FIG. 9 is a perspective view of a securing nut of the noise-reducing, enclosure device of FIG. 6;

FIG. 10 is a top, perspective view of the massage system and the noise-reducing, enclosure device of FIG. 6, with a top of the noise-reducing, enclosure device being temporarily removed;

FIG. 11 is a partial cut-away, top, perspective view of the massage system and the noise-reducing, enclosure device of FIG. 6, with a top of the noise-reducing, enclosure device being temporarily removed;

FIG. 12 is a perspective view of noise-reducing material of the noise-reducing, enclosure device of FIG. 6;

FIG. 13A is a side, perspective view of a fluid massage element and a fluid transport device of a massage system of a massage chair according to the present invention;

FIG. 13B is a perspective view of the fluid massage element and the fluid transport device of FIG. 13A; and

FIG. 14 is an elevated, front view of a massage chair, showing multiple locations where fluid massage elements may be positioned.

It should be understood that the above-attached figures are not intended to limit the scope of the present invention in any way.

### DETAILED DESCRIPTION OF THE PREFERRED EMBODIMENTS

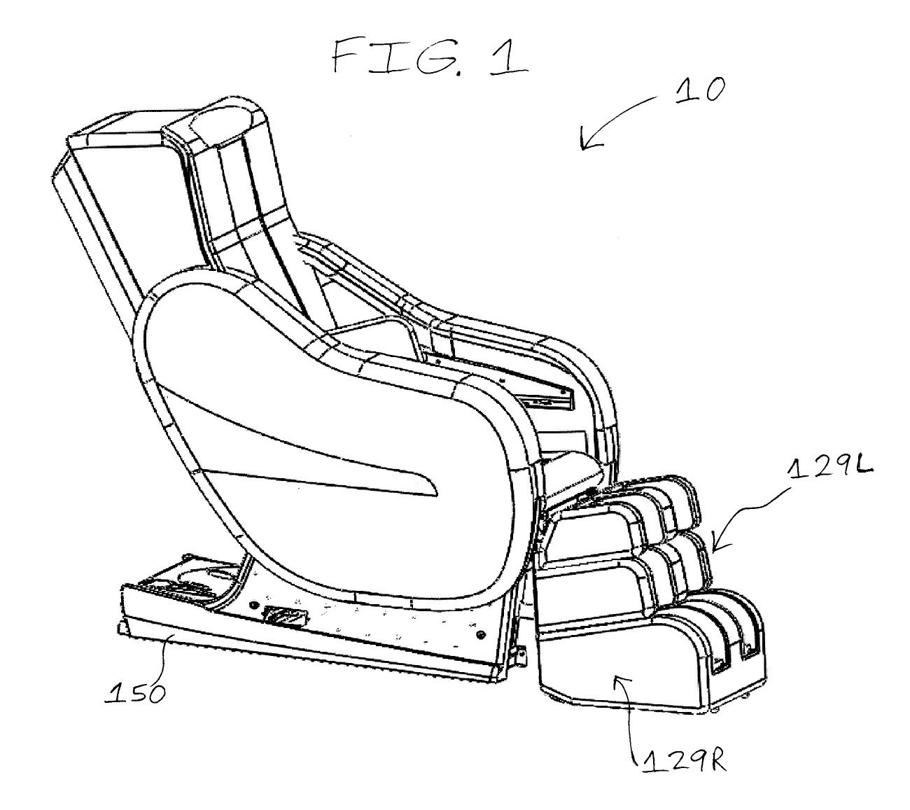

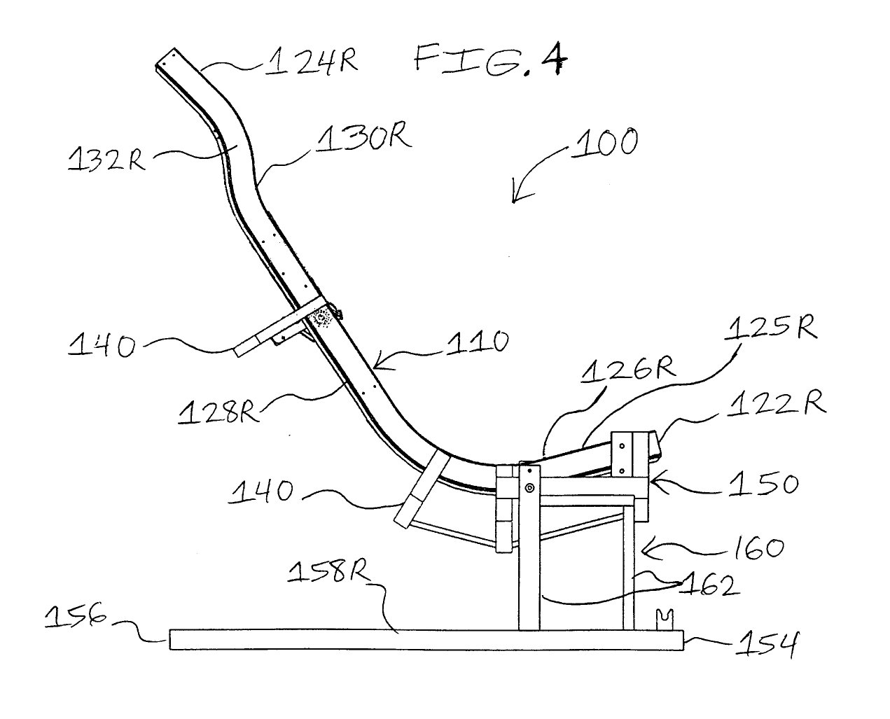

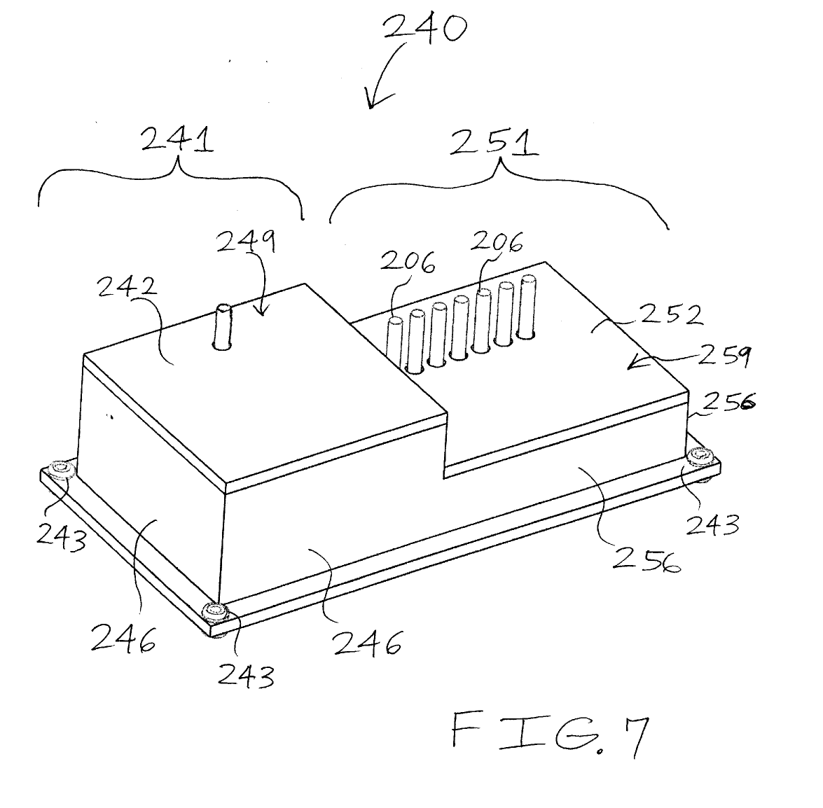

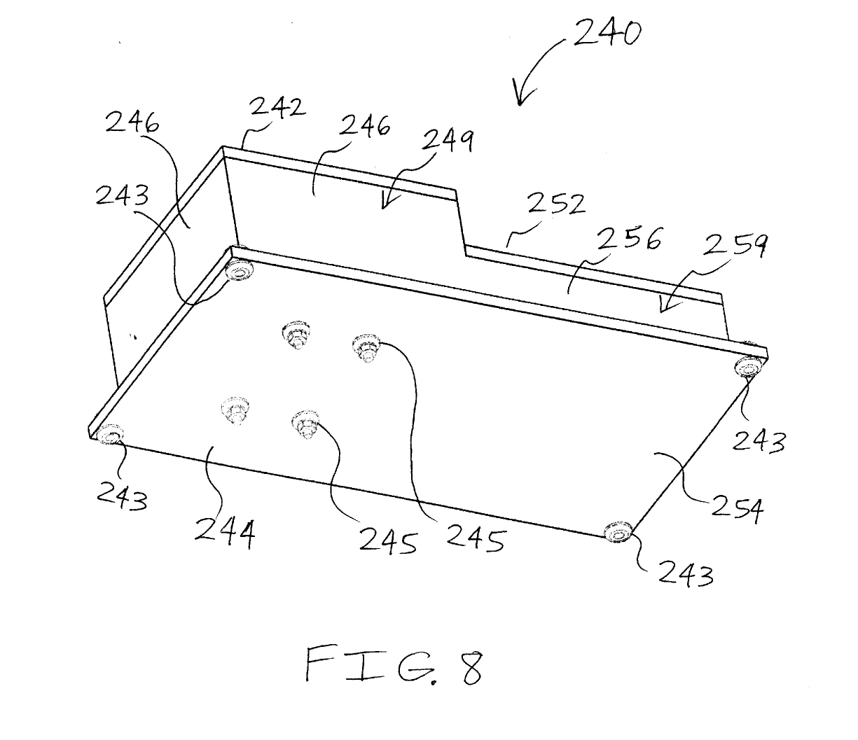

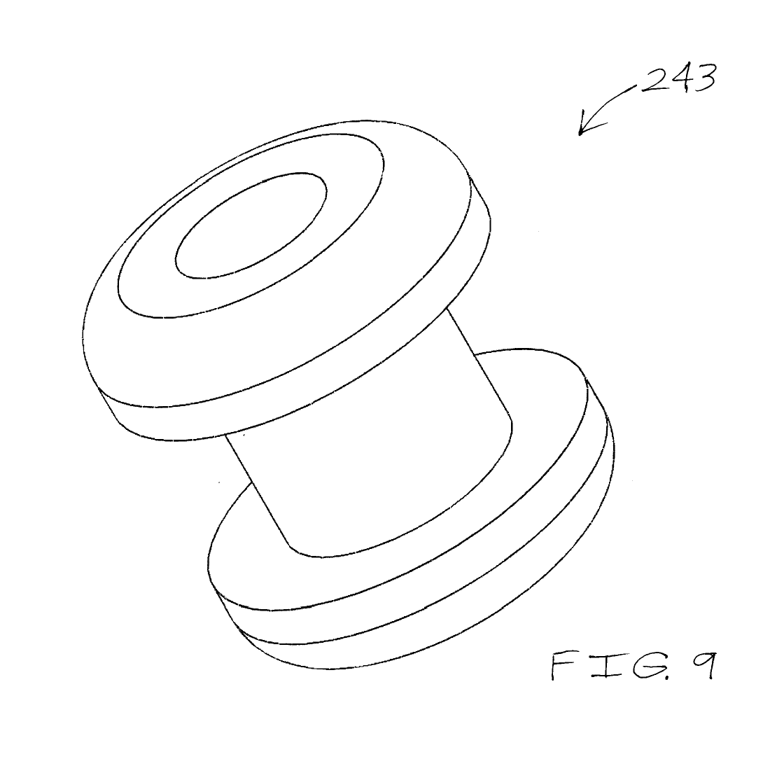

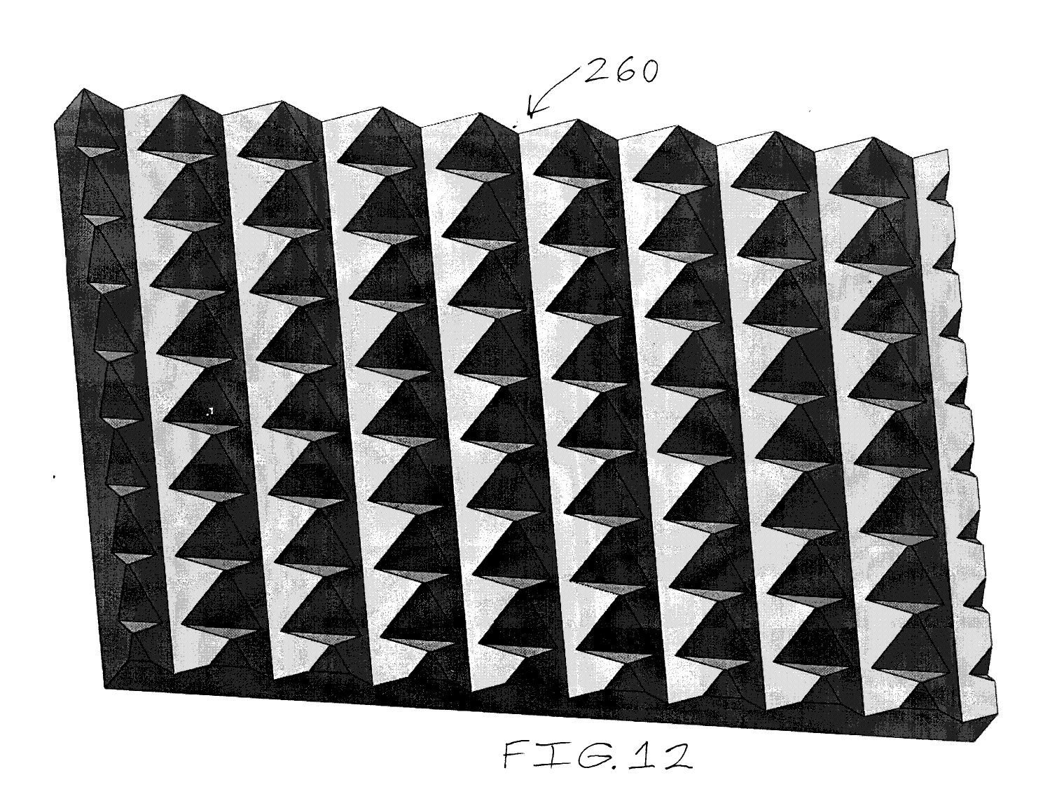

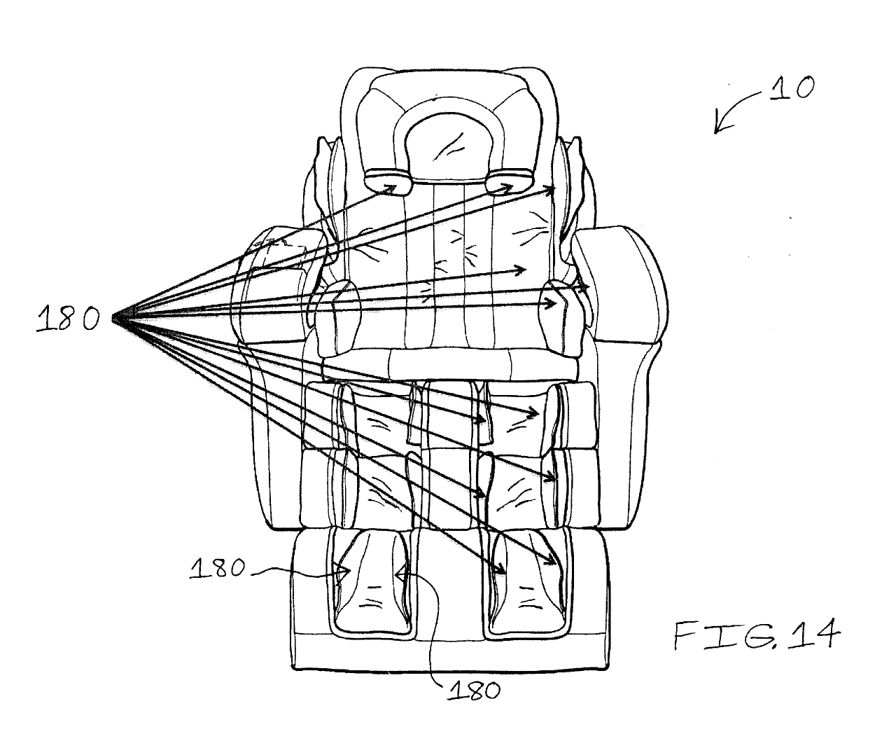

Referring to FIGS. 1-14, the present invention is directed to a massage chair 10 having a massage chair frame 110, a massage system 170 that includes a plurality of fluid massage elements 180, and a noise-reducing (or noise-absorbing, noise-containing or noise-cancelling), enclosure device 230.

The massage chair frame 110 includes a first end, a second end, a seat or bottom body area portion, and a back body area portion extending upward from the seat or bottom body area portion toward the second end. Preferably, the massage chair frame 110 also includes a thigh body area portion located between the seat or bottom body area portion and the first end, a head and neck body area portion extending upward from the back body area portion and located about the second end, and a lower leg body area portion located downward (or extending downward) from the thigh body area portion and located about the first end. In general, the massage chair frame 110 may be any massage chair frame known to one of ordinary skill in the art that comprises at least a seat or bottom body area portion and a back body area portion.

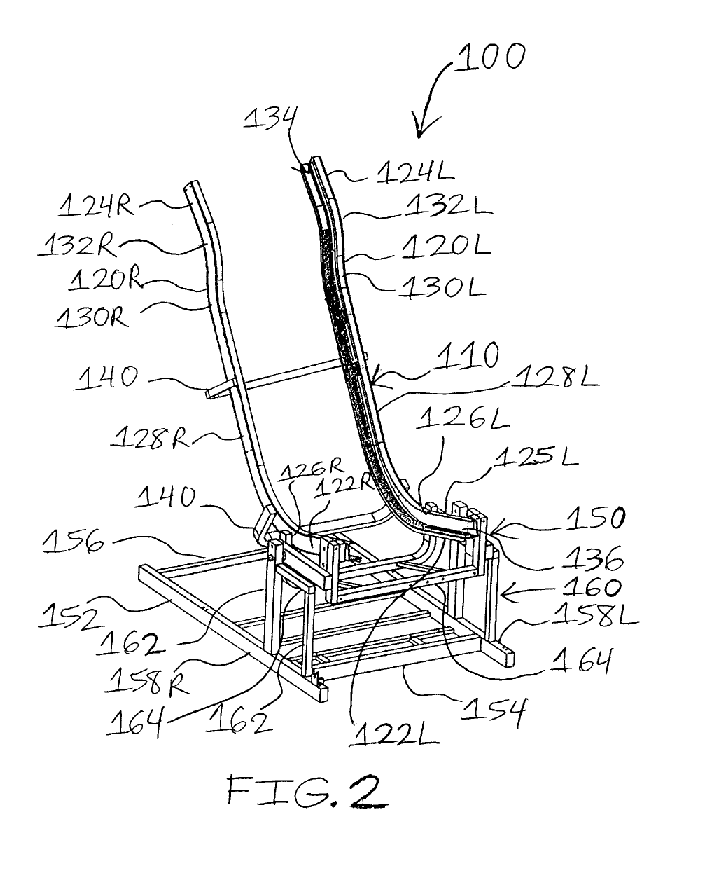

As a non-limiting example and as best shown in FIGS. 2-4, the massage chair frame 110 includes a pair of opposing guide rails 120R,120L, a plurality of guide rails stabilizing bars 140, and a base stand 150. The guide rails 120R,120L are secured to the base stand 150, and are positioned generally above the base stand 150. The base stand 150 supports the weights of the guide rails 120R,120L and, preferably, also the weight of a user (not shown) of the massage chair.

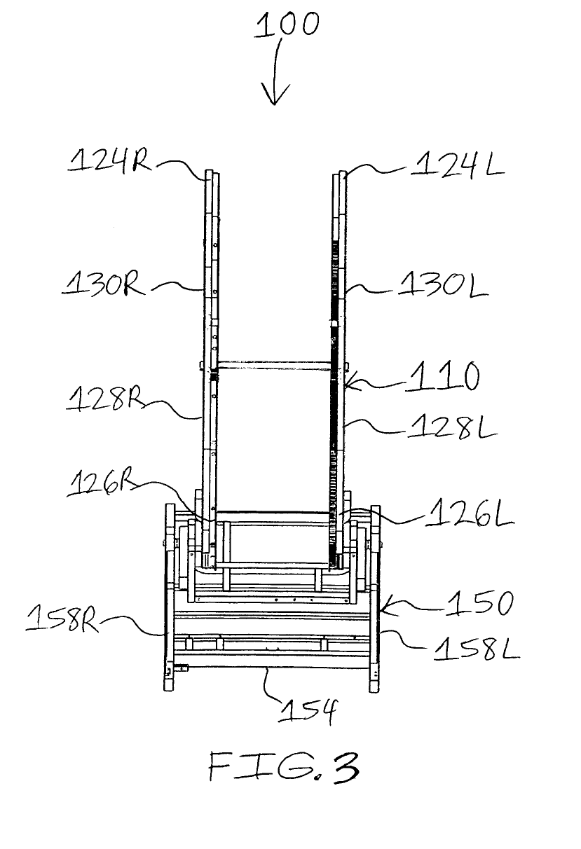

Preferably, the guide rails 120R,120L are substantially similar or mirror images of one another. Each of the guide rails 120R,120L includes a first end 122R,122L, a second end 124R,124L, a thigh body area portion 125R,125L located adjacent the first end 122R,122L, a seat or bottom body area portion 126R,126L located adjacent the thigh body area portion 125R,125L and away from the first end 122R,122L, a back body area portion 128R,128L extending upward from the bottom body area portion 126R,126L, a head and neck body area portion 130R,130L extending upward from the back body area portion 128R,128L and located about the second end 124R,124L, an outer side 132R,132L, an inner side 134, and a guide channel 136 extending from the thigh body area portion 125R,125L to the back body area portion 128R,128L, preferably to the head and neck body area portion 130R,130L, and running along the inner side 134 of the guide rail 120R,120L. The guide channel 136 may include gear teeth 138 for engaging with at least one gear member from a mechanical massage device (not shown) when the mechanical massage device moves upward and downward in a generally vertical direction from the first end 122R,122L toward the second end 124R,124L of the guide rail 120R,120L and vice versa, respectively. Preferably, each of the guide rails 120R,120L has a generally “L-shaped” configuration. In this configuration, the lower portion of the “L” includes the thigh body area portion 125R,125L and bottom body area portion 126R,126L, and the upper portion of the “L” includes the back body area portion 128R,128L and head and neck body area portion 130R,130L. As best shown in FIGS. 1 and 3, more preferably, each of the guide rails 120R,120L has a reclining “L-shaped” configuration.

Preferably, as shown in FIG. 1, the lower leg body area portion 129R,129L is a further extension of the massage chair frame 110, or is an add-on device that is secured or attached about the first end 122R,122L of the guide rails 120R,120L of the massage chair frame 110. Preferably, the lower leg body area portion 129R,129L is located downward (or extending downward) from the thigh body area portion 125R,125L and located downward (or extending downward) from the first end 122R,122L.

The plurality of guide rails stabilizing bars 140 help to stabilize the positioning of the guide rails 120R,120L relative to one another. Each of the guide rails stabilizing bars 140 has a first end 142, a second end 144, and a body portion 146 extending from the first end 142 to the second end 144. Preferably, each of the guide rails stabilizing bars 140 has a generally “U-shaped” configuration. The guide rails stabilizing bars 140 are secured at predetermined locations along the outer sides 132R,132L of the guide rails 120R,120L.

The base stand 150 includes a base 152 and a guide rails support structure 160. The base 152 includes a first or front end 154, a second or rear end 156, and a pair of opposing sides 158R,158L. The guide rails support structure 160 is secured about the front end 154 of the base 152, and is positioned above the base 152. The guide rails support structure 160 includes a plurality of vertical bars or members 162 and a plurality of horizontal bars or members 164. The plurality of vertical bars 162 extend upward from the pair of opposing sides 158R,158L of the base 152, and, along with the plurality of horizontal bars 164, form a support frame with a “square-shaped” or “rectangular-shaped” box configuration.

Since the base stand 150 supports the weights of the guide rails 120R,120L and user of the massage chair, the base stand 150 is preferably made or manufactured of a strong material, such as, but not limited to, steel, metal, wood, hard plastic, any material or combination of materials known to one of ordinary skill in the art, and any combination thereof. Also, each of the guide rails 120R,120L and plurality of guide rails stabilizing bars 140 may be made or manufactured of steel, metal, wood, plastic, any material or combination of materials known to one of ordinary skill in the art, and any combination thereof.

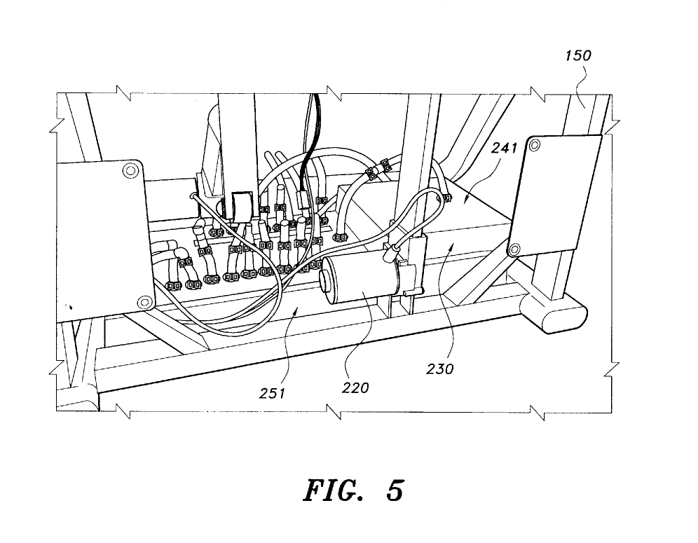

As best shown in FIGS. 5, 6 and 14-15, the massage system 170 comprises at least one fluid massage element 180, a fluid compressor or pump 190, and at least one fluid valve device 200 for regulating fluid flow into and out of the at least one fluid massage element 180. Preferably, the massage system 170 also comprises at least one fluid transport device 210 and a power source 220. Also preferably, the at least one fluid massage element 180 is a plurality of fluid massage elements 180, the at least one fluid valve device 200 is a plurality of fluid valve devices 200, and the at least one fluid transport device 210 is a plurality of fluid transport devices 210. The massage system 170 is in operational communication with the massage chair frame 110 such that the massage system 170 provides massaging effects to a user (not shown) positioned in the massage chair 10.

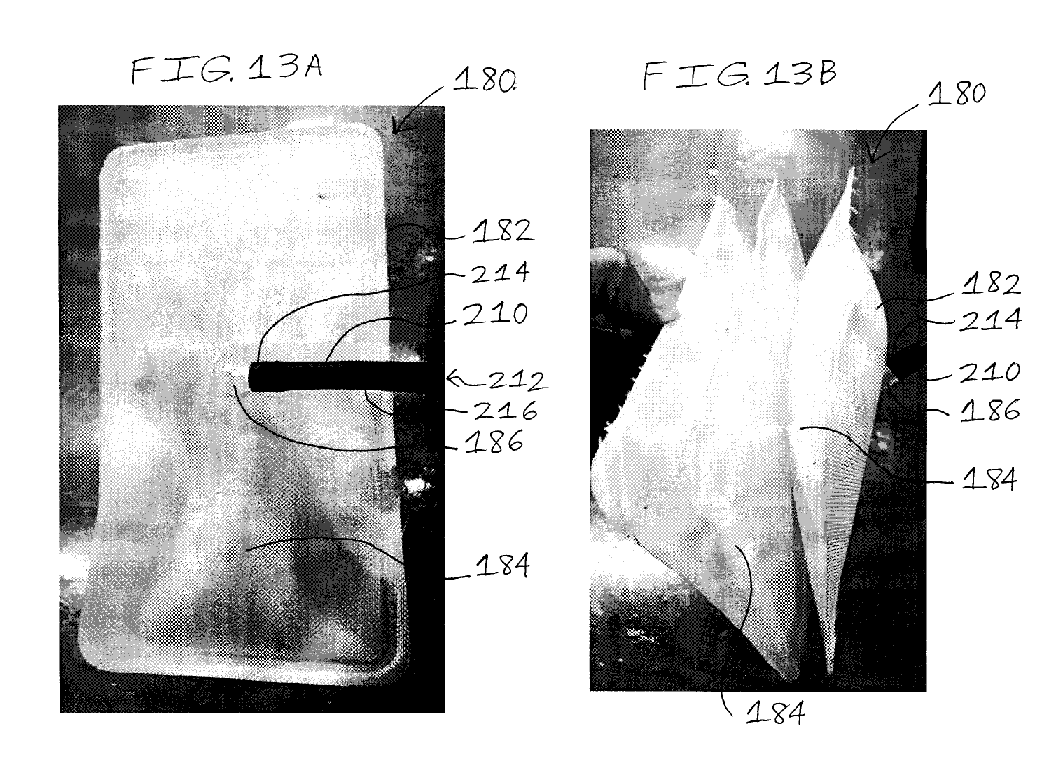

Each of the plurality of fluid massage elements 180 is adapted for having fluid transported or pumped into it by the fluid compressor or pump 190 and for having fluid withdrawn from it. The plurality of fluid massage elements 180 may be positioned at predetermined massage locations on, about, or in the vicinity of the massage chair frame 110 and/or may be moved or transported to desired massage locations by the user. The plurality of fluid massage elements 180 may be a plurality of fluid massage cells (such as, but not limited to, air cell 180 shown in FIGS. 13A and 13B), a plurality of fluid massage bags (such as, but not limited to, air bags), any fluid massage element(s) known to one of ordinary skill in the art, and any combination thereof. The air cell 180 comprises an inflatable or expandable air cell housing 182, an air cell chamber 184 defined by the air cell housing 182, and an air cell inlet and outlet 186. The fluid that is contained in and/or pumped into and out of the plurality of fluid massage elements 180 may be air, a liquid, a gel, any fluid(s) known to one of ordinary skill in the art, and any combination thereof.

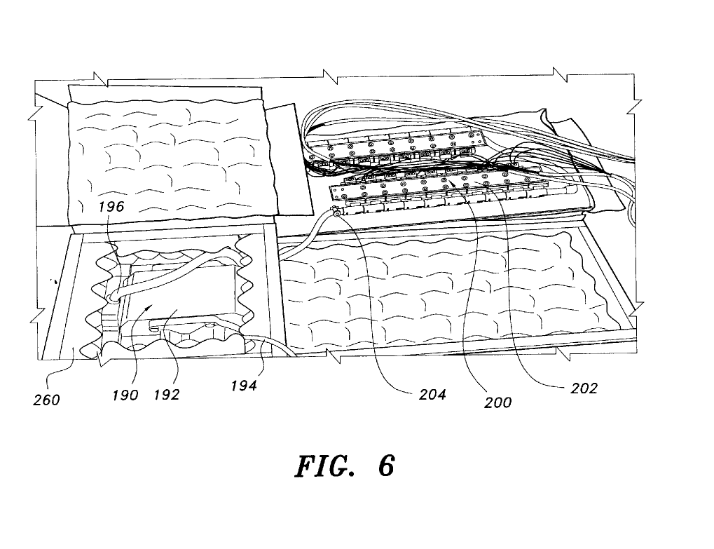

The fluid compressor or pump 190 pumps fluid into the plurality of fluid massage elements 180 such that massaging effects can be provided to the user at desired massage locations or pressure points. The fluid compressor or pump 190 comprises a fluid pump body 192, a fluid pump inlet 194, and a fluid pump outlet 196. The fluid compressor or pump 190 (such as the non-limiting example shown in FIGS. 6, 10 and 11) may be any fluid compressor or pump known to one of ordinary skill in the art that is able to pump air, a liquid, a gel, any fluid(s) known to one of ordinary skill in the art, and any combination thereof into the plurality of fluid massage elements 180.

The plurality of fluid valve devices 200 regulate fluid flow into and out of the plurality of fluid massage elements 180. Each of the fluid valve device 200 comprises a fluid valve body 202, a fluid valve inlet 204, and a fluid valve outlet 206. Each of the plurality of fluid valve devices 200 (such as the non-limiting example shown in FIGS. 6, 10 and 11) may be any fluid valve device known to one of ordinary skill in the art that is able to regulate fluid flow into and out of the corresponding fluid massage element(s) 180.

The plurality of fluid transport devices 210 transport fluid flow into and out of the plurality of fluid massage elements 180. Each of the plurality of fluid transport devices 210 (such as the non-limiting example shown in FIGS. 13A and 13B) may be any fluid transport device known to one of ordinary skill in the art that is able to transport fluid flow into and out of the corresponding fluid massage element(s) 180. The fluid transport device 210 is a transport tube 210 having a tube first end 212, a tube second end 214, and a tube body 216 extending between the tube first end 212 and tube second end 214.

The power source 220 provides power to the fluid compressor or pump 190, and may also be used to provide power to other components of the massage chair 100. The power source 220 may be a battery, a connector or cord for plugging into a power outlet (such as, but not limited to, a detachable DC power supply cord), a plug for receiving power or electricity, any power source known to one of ordinary skill in the art, and any combination thereof.

As best shown in FIGS. 5-12, the noise-reducing (or noise-absorbing, noise-containing, or noise-cancelling), enclosure device 230 comprises an enclosure housing 240 and noise-reducing (or noise-absorbing, noise-containing, or noise-cancelling) material 260 positioned inside the enclosure housing 240. The enclosure housing 240 encloses the fluid compressor or pump 190 and the plurality of fluid valve devices 200 during operation. The noise-reducing, enclosure device 230 is preferably positioned in proximity of the massage chair frame 110. As a non-limiting example shown in FIGS. 1 and 5, the noise-reducing, enclosure device 230 is positioned below the seat or bottom body area portion 126R,126L of the massage chair frame 110.

As a non-limiting example and as best shown in FIGS. 6-11, the enclosure housing 240 has a first section 241 that comprises a top 242, a bottom 244, a plurality of sides 246, an inner surface 248, and an outer surface 249, and a second section 251 that comprises a top 252, a bottom 254, a plurality of sides 256, an inner surface 258, and an outer surface 259. Preferably, the inner surfaces 248,258 and noise-reducing (or noise-absorbing, noise-containing, or noise-cancelling) material 260 help to form noise-reducing (or noise-absorbing, noise-containing, or noise-cancelling) walls for the enclosure housing 240. The first section 241 of the enclosure housing 240 encloses (partially, substantially, or fully encloses) the fluid compressor or pump 190 while the second section 251 of the enclosure housing 240 encloses (partially, substantially, or fully encloses) the plurality of fluid valve devices 200 such that noise generated from or made by the fluid compressor or pump 190 and the plurality of fluid valve devices 200 during operation is reduced, contained or eliminated. The enclosure housing 240 also has a plurality of foot elements 243 positioned at predetermined locations on the periphery of the enclosure housing 240, and a plurality of screw and nut elements 245 positioned at predetermined locations.

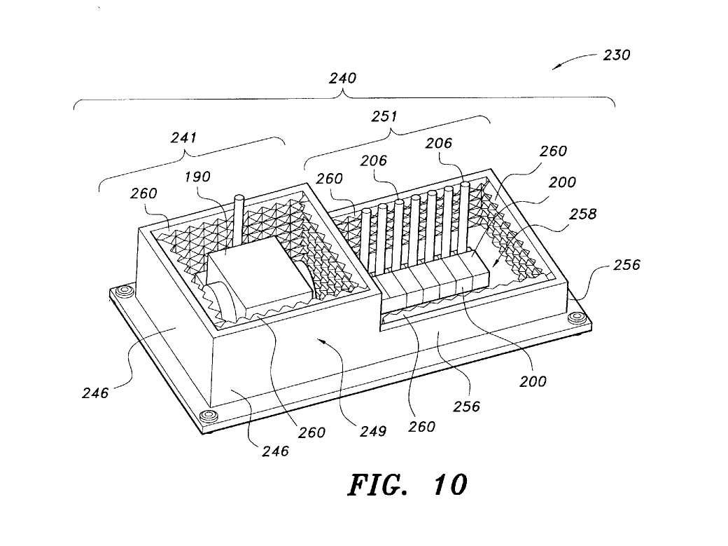

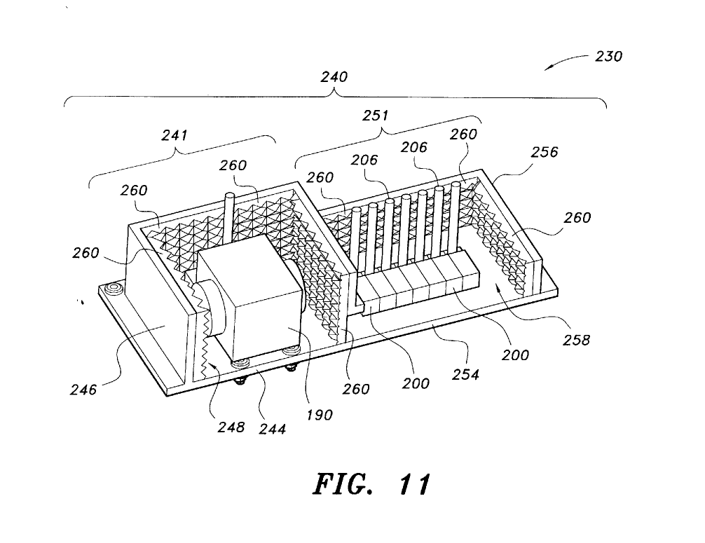

Preferably, the noise-reducing (or noise-absorbing, noise-containing, or noise-cancelling) material 260 is positioned inside the enclosure housing 240 in such a way that it surrounds the fluid compressor or pump 190 and the plurality of fluid valve devices 200 such that noise generated from or made by the fluid compressor or pump 190 and the plurality of fluid valve devices 200 during operation is reduced, contained or eliminated. Preferably, as shown in FIGS. 10 and 11, all of the inner surfaces 248,258 of the enclosure housing 240 are covered by the noise-reducing material 260. Preferably, all of the electro-mechanical components positioned inside the enclosure housing 240 are fully surrounded by the noise-reducing material 260. The noise-reducing material 260 may be foam, noise-reducing foam, noise-absorbing foam, noise-containing foam, noise-cancelling foam, any noise-reducing material known to one of ordinary skill in the art, any noise-absorbing material known to one of ordinary skill in the art, any noise-containing material known to one of ordinary skill in the art, any noise-cancelling material known to one of ordinary skill in the art, and any combination thereof.

When in use or in operation, the user (not shown) may activate the massage system 170 of the massage chair 100 by or via pushing, touching, using voice command for use on or with, using a mechanical or remote control for use on or with, or any other activation method known to one of ordinary skill in the art, an activation, start, control or command button, touch area, box or panel, or any other activation method or element known to one of ordinary skill in the art. Preferably, the user is able to control the massage producing-effects of the plurality of fluid massage elements 180 such that the plurality of fluid massage elements 180 provide massage producing-effects to a desired body part area(s), such as the thighs, bottom, lower back, upper back, head and neck, and/or lower leg of the user so that desired body part area(s) of the user can receive massage effects or benefits from the plurality of fluid massage elements 180 when desired.

It is to be understood that the present invention is not limited to the embodiments described above or as shown in the attached figures, but encompasses any and all embodiments within the spirit of the invention.

What is claimed is:

1. A massage chair comprising:
a massage chair frame comprising a first end, a second end, a seat or bottom body area portion, a thigh body area portion located between said bottom body area portion and said first end, and a back body area portion extending upward from said bottom body area portion toward said second end;
a massage system in operational communication with said massage chair frame such that said massage system provides massaging effects to a user positioned in said massage chair,
wherein said massage system comprises at least one fluid massage element, a fluid compressor or pump, at least one fluid valve device for regulating fluid flow into and out of said at least one fluid massage element, at least one fluid transport device for transporting fluid flow into and out of said at least one fluid massage element, and a power source,
wherein each of said at least one fluid massage element is adapted for having fluid transported or pumped into it by said fluid compressor or pump and for having fluid withdrawn from it,
wherein each of said at least one fluid massage element is positioned at a predetermined massage location about said massage chair frame and/or may be moved or transported to a desired massage location by the user, and
wherein each of said at least one fluid massage element provides massaging effects to a corresponding body area portion of the user; and
a noise-reducing, enclosure device comprising an enclosure housing and noise-reducing material positioned inside said enclosure housing,
wherein said enclosure housing encloses said fluid compressor or pump and said at least one fluid valve device during operation so that noise generated from or made by said fluid compressor or pump and said at least one fluid valve device during operation is reduced or eliminated.

2. The massage chair according to claim 1, wherein said massage chair frame further comprises a head and neck body area portion extending upward from said back body area portion and located about said second end, and a lower leg body area portion located downward from said thigh body area portion and located about said first end.

3. The massage chair according to claim 1, wherein each of said at least one fluid massage element is selected from the group consisting of an air cell, an air bag, and any combination thereof.

4. The massage chair according to claim 1, wherein said noise-reducing, enclosure device is positioned in proximity of said massage chair frame.

5. The massage chair according to claim 4, wherein said noise-reducing, enclosure device is positioned below said seat or bottom body area portion of said massage chair frame.

6. The massage chair according to claim 1, wherein said enclosure housing comprises a top, a bottom, a plurality of sides, an inner surface, and an outer surface.

7. The massage chair according to claim 1, wherein said noise-reducing material is selected from the group consisting of foam, noise-reducing foam, and any combination thereof.

8. The massage chair according to claim 1, wherein said noise-reducing material surrounds said fluid compressor or pump and said at least one fluid valve device such that noise generated from or made by said fluid compressor or pump and said at least one fluid valve device during operation is reduced or eliminated.

9. The massage chair according to claim 1, wherein said massage chair frame has a generally “L-shaped” configuration.

10. A massage chair comprising:
a massage chair frame comprising a pair of opposing guide rails,
wherein each of said guide rails comprises a first end, a second end, a thigh body area portion located about said first end, a bottom body area portion located proximate said thigh body area portion and away from said first end, a back body area portion extending upward from said bottom body area portion, an outer side, an inner side, and a guide channel extending from said thigh body area portion to said back body area portion, and
wherein said guide channel runs along said inner side, and
wherein said guide channel comprises gear teeth;
a massage system in operational communication with said massage chair frame such that said massage system provides massaging effects to a user positioned in said massage chair,
wherein said massage system comprises at least one fluid massage element, a fluid compressor or pump, at least one fluid valve device for regulating fluid flow into and out of said at least one fluid massage element, at least one fluid transport device for transporting fluid flow into and out of said at least one fluid massage element, and a power source,
wherein each of said at least one fluid massage element is adapted for having fluid transported or pumped into it by said fluid compressor or pump and for having fluid withdrawn from it,
wherein each of said at least one fluid massage element is positioned at a predetermined massage location about said massage chair frame and/or may be moved or transported to a desired massage location by the user, and
wherein each of said at least one fluid massage element provides massaging effects to a corresponding body area portion of the user; and
a noise-reducing, enclosure device comprising an enclosure housing and noise-reducing material positioned inside said enclosure housing,
wherein said enclosure housing encloses said fluid compressor or pump and said at least one fluid valve device during operation so that noise generated from or made by said fluid compressor or pump and said at least one fluid valve device during operation is reduced or eliminated.

11. The massage chair according to claim 10, wherein each of said guide rails further comprises a head and neck body area portion extending upward from said back body area portion and located about said second end, and a lower leg body area portion located downward from said thigh body area portion and located about said first end.

12. The massage chair according to claim 10, wherein each of said at least one fluid massage element is selected from the group consisting of an air cell, an air bag, and any combination thereof.

13. The massage chair according to claim 10, wherein said noise-reducing, enclosure device is positioned in proximity of said massage chair frame.

14. The massage chair according to claim 13, wherein said noise-reducing, enclosure device is positioned below said seat or bottom body area portion of each of said guide rails.

15. The massage chair according to claim 10, wherein said enclosure housing comprises a top, a bottom, a plurality of sides, an inner surface, and an outer surface.

16. The massage chair according to claim 10, wherein said noise-reducing material is selected from the group consisting of foam, noise-reducing foam, and any combination thereof.

17. The massage chair according to claim 10, wherein said noise-reducing material surrounds said fluid compressor or pump and said at least one fluid valve device such that noise generated from or made by said fluid compressor or pump and said at least one fluid valve device during operation is reduced or eliminated.

18. The massage chair according to claim 10, wherein each of said at least one guide rail has a generally “L-shaped” configuration.
